(19) United States
(12) Patent Application Publication
(10) Pub. No.: US 2021/0374829 A1
(43) Pub. Date: Dec. 2, 2021

(54) METHODS, SYSTEMS, AND MEDIA FOR COORDINATING RECOMMENDATIONS

(71) Applicant: 141 Fifth Limited, London (GB)

(72) Inventor: Bonnie Takhar, London (GB)

(21) Appl. No.: 17/292,440

(22) PCT Filed: Nov. 15, 2019
(86) PCT No.: PCT/IB2019/001258

§ 371 Date: May 9, 2021

Related U.S. Application Data
(60) Provisional application No. 62/767,722, filed on Nov. 15, 2018.

(51) Int. Cl. G06Q 30/06; G06Q 30/02; G06F 16/955

(52) U.S. Cl. CPC G06Q 30/0631; G06F 16/955; G06Q 30/0214

(57) ABSTRACT

Mechanisms for coordinating recommendations are provided, the mechanisms comprising: receiving a first link that identifies a product to be recommended by a recommender and that is associated with a vendor server associated with a first domain; creating, using a hardware processor, a second link from the first link, wherein the second link identifies the product and wherein the second link is associated with a second domain that is different from the first domain; sending the second link to a recipient device as part of a recommendation of the product; determining, using the hardware processor, that the second link has been selected by a user of the recipient device; redirecting the recipient device to a vendor server identified by the first link; receiving information that a purchase was made in connection with the recommendation of the product; and causing a display to present commission information based on the purchase.

### CROSS-REFERENCE TO RELATED APPLICATIONS

This application is a U.S. National Stage Entry under 35 U.S.C. § 371 of International Application No. PCT/IB2019/001258, filed Nov. 15, 2019, which claims the benefit of U.S. Provisional Patent Application No. 62/767,722, filed Nov. 15, 2018, each of which is hereby incorporated by reference herein its entirety.

### TECHNICAL FIELD

The disclosed subject matter relates to methods, systems, and media for coordinating recommendations.

### BACKGROUND

People often want to make recommendations of items that they like to friends. For example, a person may want to recommend a particular item of clothing to a friend. Additionally, businesses may appreciate having their products recommended, because a personal recommendation may carry more weight than a generic advertisement for a particular product. However, it can be difficult to make a recommendation. For example, to recommend a particular product sold through a website to a friend, a user may have to go to the website, search for the product, and send a link to the friend, which can be time-consuming, and users may lack the motivation to make such a recommendation.

Accordingly, it is desirable to provide new methods, systems, and media for coordinating recommendations.

### SUMMARY

In accordance with some embodiments, methods, systems, and media for coordinating recommendations are provided.

In some embodiments, method for coordinating recommendations are provided, the methods comprising: receiving a first link that identifies a product to be recommended by a recommender and that is associated with a vendor server associated with a first domain; creating, using a hardware processor, a second link from the first link, wherein the second link identifies the product and wherein the second link is associated with a second domain that is different from the first domain; sending the second link to a recipient device as part of a recommendation of the product; determining, using the hardware processor, that the second link has been selected by a user of the recipient device; redirecting the recipient device to a vendor server identified by the first link; receiving information that a purchase was made in connection with the recommendation of the product; and causing a display to present commission information based on the purchase.

In some embodiments, systems for coordinating recommendations are provided, the systems comprising: a memory; and a hardware processor coupled to the memory and configured to: receive a first link that identifies a product to be recommended by a recommender and that is associated with a vendor server associated with a first domain; create a second link from the first link, wherein the second link identifies the product and wherein the second link is associated with a second domain that is different from the first domain; send the second link to a recipient device as part of a recommendation of the product; determine that the second link has been selected by a user of the recipient device; redirect the recipient device to a vendor server identified by the first link; receive information that a purchase was made in connection with the recommendation of the product; and cause a display to present commission information based on the purchase.

In some embodiments, non-transitory computer-readable media containing computer executable instructions that, when executed by a processor, cause the processor to perform a method for coordinating recommendations are provided, the method comprising: receiving a first link that identifies a product to be recommended by a recommender and that is associated with a vendor server associated with a first domain; creating a second link from the first link, wherein the second link identifies the product and wherein the second link is associated with a second domain that is different from the first domain; sending the second link to a recipient device as part of a recommendation of the product; determining that the second link has been selected by a user of the recipient device; redirecting the recipient device to a vendor server identified by the first link; receiving information that a purchase was made in connection with the recommendation of the product; and causing a display to present commission information based on the purchase.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an example of an information flow diagram for coordinating recommendations in accordance with some embodiments of the disclosed subject matter.

FIGS. 2A and 2B show examples of user interfaces for searching for vendors in accordance with some embodiments of the disclosed subject matter.

FIG. 3 shows an example of a user interface for viewing products associated with a vendor in accordance with some embodiments of the disclosed subject matter.

FIG. 4 shows an example of a user interface for selecting a product to recommend in accordance with some embodiments of the disclosed subject matter.

FIG. 5 shows an example of a user interface for setting parameters associated with a recommendation in accordance with some embodiments of the disclosed subject matter.

FIG. 6 shows an example of a user interface for transmitting a recommendation in accordance with some embodiments of the disclosed subject matter.

FIG. 7 shows an example of a user interface for receiving a recommendation in a messaging interface in accordance with some embodiments of the disclosed subject matter.

FIGS. 8A and 8B show examples of user interfaces for viewing metrics associated with recommendations in accordance with some embodiments of the disclosed subject matter.

FIG. 9 shows a schematic diagram of an illustrative system suitable for implementation of mechanisms described herein for coordinating recommendations in accordance with some embodiments of the disclosed subject matter.

FIG. 10 shows a detailed example of hardware that can be used in a server and/or a user device of FIG. 9 in accordance with some embodiments of the disclosed subject matter.

### DETAILED DESCRIPTION

In accordance with various embodiments, mechanisms (which can include methods, systems, and media) for coordinating recommendations are provided.

In some embodiments, the mechanisms described herein can be used by a recommendation platform for coordinating and managing recommendations for products. For example, in some embodiments, a recommendation platform can be associated with an application (e.g., an application that executes on a mobile device, such as a mobile phone, tablet computer, wearable computer, and/or any other suitable type of device) that displays products available for purchase from multiple vendors (e.g., vendors of clothing, books, toys, and/or any other suitable types of products). In some embodiments, each vendor can be a vendor that has partnered with a recommendation platform to allow their products to be sold in association with the recommendation platform.

In some embodiments, the mechanisms can allow a first user (a recommender) to recommend a particular product to a second user, for example, by causing a link to the product to be transmitted to a device of the second user (a recipient) via a messaging interface (e.g., via a text message, email, social networking service, and/or in any other suitable manner). In some embodiments, in response to determining that a recommended product has been purchased by a recipient of a recommendation, the mechanisms can cause a recommender who recommended the product to receive a commission. In some embodiments, the mechanisms can allow a recommender who recommends a product to indicate a charity that is to receive a portion of a commission paid to the recommender if the recommended product is purchased.

Note that, in some embodiments, charities that receive portions of paid commissions and/or vendors whose products are available for purchase through a recommendation platform can partner with the recommendation platform. That is, in some embodiments, charities and/or vendors may be vetted in any suitable manner and/or can install any suitable code modules to allow the charities and/or the vendors to integrate with the recommendation platform. For example, in some embodiments, a vendor can install any suitable software or code that transmits information indicating products browsed through a website associated with the vendor to the recommendation platform, that transmits payment corresponding to a commission from a purchased product to the recommendation platform, and/or that performs any other suitable function. As another example, in some embodiments, a charity can establish an account with the recommendation platform that allows the charity to receive donations that are portions of commissions from a sale of recommended products.

Additionally, note that, in some embodiments, the mechanisms described herein can collect any suitable data relating to: products that are recommended; vendors associated with recommended products; recommenders who recommend products; recommenders whose recommendations lead to product purchases; products that are purchased; recipients who purchase products; and/or any other suitable data. In some embodiments the data can be used for any suitable purpose. For example, in some embodiments, the data can be used to personalize recommendations for a user of a recommendation platform. As a more particular example, in some embodiments, the data can be used to recommend particular vendors, to recommend particular charities for donation, and/or any other suitable personalization.

In some embodiments, the data can be used to identify patterns of behavior among users of a recommendation platform, such as demographics of users likely to share a commission with a charity, demographics of users likely to purchase products from particular vendors, etc.

In some embodiments, the mechanisms described herein can receive data relating to recommended products and/or purchased products using any suitable technique or combination of techniques. For example, in some embodiments, a server associated with a recommendation platform can receive data from a server associated with a vendor via a tracking script (e.g., a JavaScript script, and/or any other suitable type of code or software) used by the vendor to collect data associated with browsing of a website associated with the vendor. In some embodiments, the received data can be stored and/or analyzed by a server associated with a recommendation platform as described above.

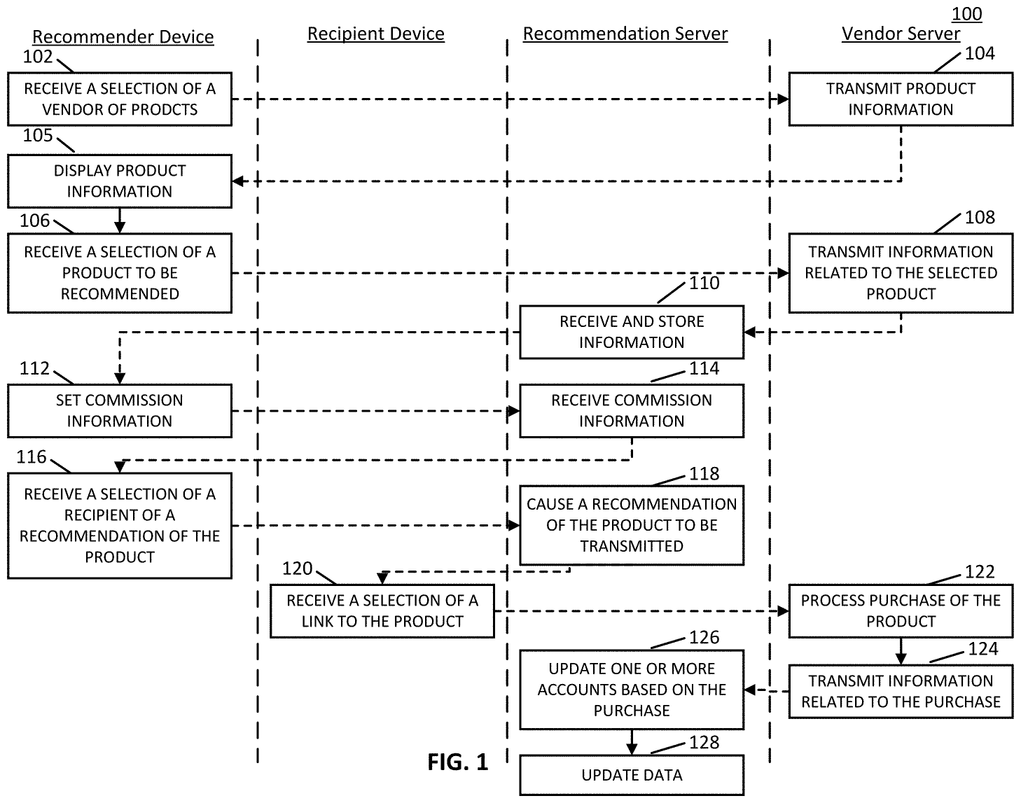

Turning to FIG. 1, an example 100 of an information flow diagram for coordinating recommendations is shown in accordance with some embodiments of the disclosed subject matter. As illustrated, in some embodiments, blocks of process 100 can be executed on a recommender device, a recipient device, a recommendation server, and/or a vendor server. Note that, in some embodiments, the recommender device can be associated with a first user (e.g., a user that is making a recommendation of a product), and the recipient device can be associated with a second user (e.g., a user that is receiving the recommendation of the product). In some embodiments, blocks of process 100 executed by the recommender device can be executed in connection with any suitable application, such as an application for making product recommendations. In some such embodiments, the application can be associated with the recommendation server. For example, the application can be provided by and/or supported by an entity associated with the recommendation server.

At 102, the recommender device can receive a selection of a vendor or of one or more products which a recommender may want to recommend. In some embodiments, the vendor of the product can be any suitable vendor, such as a vendor of clothing, a vendor of toys, a vendor of books, and/or any other suitable type of vendor. In some embodiments, the vendor of the product can be a vendor that has agreed to be listed as a vendor in an application associated with the recommendation server.

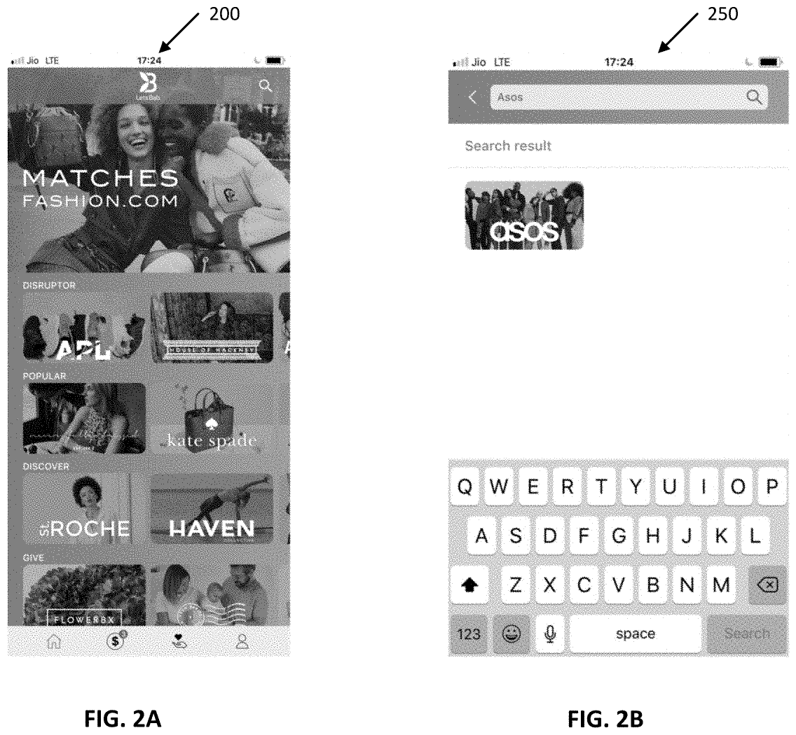

In some embodiments, the recommender device can present a user interface for selecting a vendor. Turning to FIG. 2A, an example 200 of a user interface for presenting available vendors is shown in accordance with some embodiments of the disclosed subject matter. In some embodiments, a particular vendor can be selected by selecting an icon associated with the vendor, and/or in any other suitable manner.

As illustrated, in some embodiments, available vendors can be presented in any suitable manner. For example, in some embodiments, available vendors can be presented within any suitable categories, such as popular vendors (e.g., vendors who products are most frequently purchased in response to recommendations), vendors of particular types of items (e.g., women's clothing, shoes, toys, books, and/or any other suitable types of items), vendors a recommender has previously purchased items from, and/or in any other suitable manner. In some embodiments, vendors can be presented within user interface 200 based on a likelihood each presented vendor will be of interest to recommender (e.g., vendors likely to be of interest to the recommender can be included as recommended vendors in user interface 200, vendors likely to be of interest to the user can be presented in more prominent locations within user interface 200, and/or in any other suitable manner). For example, in some embodiments, previous purchases of products from a first vendor can cause a second vendor that sells products similar to those sold by the first vendor to be presented within user interface 200 as a recommended vendor. As a more particular example, in an instance in which a recommender has previously purchased a particular style of clothing (e.g., women's clothing, men's clothing, children's clothing, business attire, and/or any other suitable style), a different vendor that sells a similar style of clothing can be included in user interface 200.

Note that in some embodiments, the recommendation server can determine an order in which vendors are listed in user interface 200. For example, in some embodiments, the recommendation server can sort popular vendors based on previously collected vendor and/or sales information. In some such embodiments, vendor information and/or sales information can be collected across multiple users. As another example, in some embodiments, in instances in which vendors are listed in a manner based on preference of a recommender (e.g., based on vendors the recommender has previously purchased products from, based on vendors the recommender has previously recommended products from, based on vendors that sell products the recommender has previously shown an interest in, and/or based on any other suitable recommender preferences), the vendors can be identified and/or ranked for presentation in user interface 200. Note that, in some embodiments, any suitable machine learning techniques can be used to identify vendors to be included in user interface 200. For example, in some embodiments, any suitable recommendation algorithm (e.g., collaborative filtering, and/or any other suitable recommendation algorithm) can be used to identify one or more vendors similar to a vendor a recommender has previously purchased products from and/or recommended products from.

Additionally, note that, in some embodiments, vendors and products can be selected for presentation to a recommender based on purchases made by the recommender. In some embodiments, purchase information can be obtained in any suitable manner. For example, in some embodiments, purchase information can be obtained through an API to a vendor. As another example, in some embodiments, purchase information can be obtained by scanning emails of the recommender for order/purchase confirmation. As still another example, in some embodiments, credit cards and/or bank accounts can be monitored to determine vendors and/or products that were purchased by a recommender and that information used as purchase information.

In some embodiments, a recommender can search for a particular vendor using a search interface, as shown in user interface 250 of FIG. 2B. As illustrated, in some embodiments, text corresponding to a name of a particular vendor can be entered in a search interface as a search query, and one or more results corresponding to the search query can be presented in user interface 250. Note that, in instances where no suitable result is identified in response to the search query (e.g., in an instance where a user enters a name of a particular vendor, but no vendor with that name is identified), any suitable notification can be presented within user interface 250. For example, in some embodiments, a notification can be presented that states that no vendor corresponding to the entered search query was found. As another example, in some embodiments, the recommendation server can identify a vendor similar to the name of a vendor that was entered in the search query. As a more particular example, in an instance where a name of a vendor of a particular style of clothing was entered as a search query but where the entered vendor has not agreed to be associated with the recommendation platform, the recommendation server can identify a second vendor that sells the same or a similar style of clothing and can present an indication of the second vendor instead.

Note that, in some embodiments, user interfaces 200 and/or 250 can be presented in connection with an application associated with a recommendation platform, such as a recommendation platform associated with an application associated with the recommendation server.

Referring back to FIG. 1, at 104, the vendor server can transmit information for available products to the recommender device. In some embodiments, the vendor server can correspond to a server associated with a vendor selected by a user of the recommender device at 102.

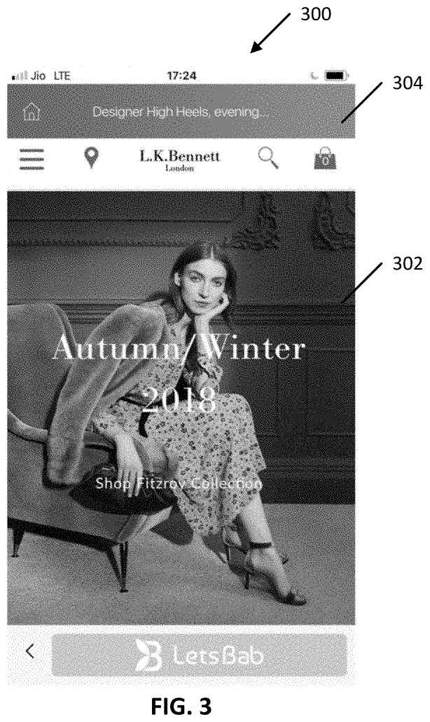

Turning to FIG. 3, an example 300 of a user interface for presenting available products 302 associated with a selected vendor is shown in accordance with some embodiments of the disclosed subject matter. As illustrated, in some embodiments, available products 302 can be presented within a user interface associated with the vendor, and the user interface associated with the vendor can be presented within an application associated with the recommendation platform. For example, in some embodiments, selection of a home button 304 can cause user interface 300 to navigate back to a vendor selection interface, such as user interface 200 and/or 250, as shown in and described above in connection with FIGS. 2A and 2B.

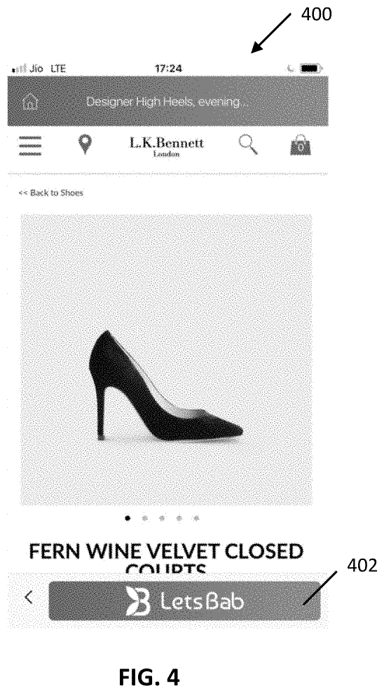

Turning to FIG. 4, an example 400 of a user interface for presenting information related to an available product is shown in accordance with some embodiments of the disclosed subject matter. As illustrated, the information can include an image or multiple images of the particular product that a user of the recommended device can scroll through. In some embodiments, any other suitable information can be presented in user interface 400, such as a price of the product, reviews or a rating of the product, and/or any other suitable information. Note that, similarly to interface 300 as described above in connection with FIG. 3, in some embodiments, user interface 400 can be a user interface provided by the vendor server that is presented within an application associated with the recommendation platform corresponding to the recommendation server.

Referring back to FIG. 1, in some embodiments, at 105, the available products can be presented on the recommender device in any suitable manner. For example, in instances where the available products are presented within a user interface associated with the vendor that is presented within an application associated with the recommendation server (as shown in and described above in connection with FIGS. 3 and 4), the vendor server can use any suitable code or software to coordinate with the recommendation server. For example, in some embodiments, the vendor server can have previously executed any suitable module that allows content of a website associated with the vendor (e.g., a website that presents available products, a website that allows purchase of products provided by the vendor, and/or any other suitable website associated with the vendor) to be displayed through the application associated with the recommendation server.

Note that, in some embodiments, the vendor server can execute any suitable code (e.g., JavaScript code, and/or any other suitable code) that tracks product browsing information by the recommender device. For example, in some embodiments, the vendor server can store information indicating types of products a user of the recommender device has selected or viewed, types of products a user of the recommender device has browsed, a duration of time a user of the recommender device has spent viewing a particular product, and/or any other suitable browsing information. In some such embodiments the vendor server can transmit the browsing information to the recommendation server at any suitable time(s). In some such embodiments, the recommendation server can use the information received from the vendor server for any suitable purpose(s). For example, in some embodiments, the recommendation server can use the received information to identify other vendors a user of the recommender device is likely to be interested in, as described above in connection with 102 and FIG. 2A.

At 106, the recommender device can receive a selection of a product to be recommended from the recommender. For example, in some embodiments, the recommender can select a particular product from the available products associated with the vendor server by selecting an icon 402, as shown in FIG. 4.

At 108, the vendor server can transmit information related to the selected product to the recommendation server. For example, in some embodiments, the transmitted information can indicate any suitable information about the product, such as a price of the product, a type associated with the product (e.g., that the product is casual clothing, that the product is a non-fiction book, and/or any other suitable type associated with the product), demographic information associated with people who have typically bought the product from the vendor (e.g., men, women, people of a particular age range, an identifier (ID) which identifies the recommender, a time of the recommendation, and/or any other suitable demographic information), and/or any other suitable information.

For example, in some embodiments, the vendor server can transmit the information as a link. This link can contain the uniform resource locator (URL) of the selected product and ID which identifies the recommender. Subsequently, when the recipient (recommendee) opens the link, this ID can be transmitted to the recommendation server. Transmission to the vendor server can done by a script which is contained in the recommendation server link described below, in some embodiments.

At 110, the recommendation server can receive and store the transmitted information. Note that, in some embodiments, the recommendation server can store the information in any suitable manner. For example, in some embodiments, the recommendation server can store the information in connection with information about a user of the recommender device and/or in connection with an identifier of a user of the recommender device. Note that, in some embodiments, the recommendation server can use the information for any suitable purpose. For example, in some embodiments, the information can be added to a collection of data that indicates browsing information and recommended product information collected from multiple users of the recommendation platform. In some such embodiments, the data can be used to determine any suitable trends about users of the recommendation platform, as described below in more detail in connection with 128. As another example, in some embodiments, the information can be used to personalize vendor recommendations for a user of the recommended device, as described above in connection with 102.

In some embodiments, at 110, the recommendation server can reformat the link sent at 108 into another link format (a recommendation server link) that corresponds to the recommendation server and store the recommendation server link. For example, in some embodiments this recommendation server link can identify a domain of the recommendation server.

At 112, the recommender device can set commission information. For example, in some embodiments, the commission information can include information indicating how a commission received from sale of the selected product to another user is to be divided. As a more particular example, in some embodiments, the commission information can indicate that a particular percentage of the commission is to be donated to a particular charity, and/or any other suitable information.

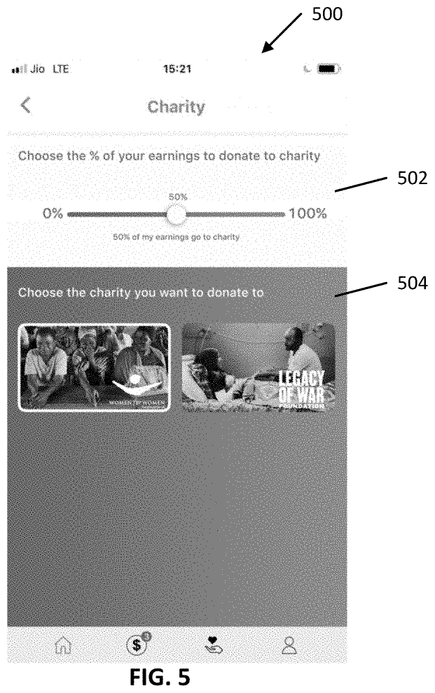

Turning to FIG. 5, an example 500 of a user interface for setting commission information is shown in accordance with some embodiments of the disclosed subject matter. As illustrated, in some embodiments, user interface 500 can include a slider 502 and a group of charities 504.

In some embodiments, slider 502 can be used to set a portion of a commission that is to be donated to a particular charity. For example, as illustrated in FIG. 5, in some embodiments slider 502 can be used to select a value between 0% (e.g., 0% of a commission donated to charity) and 100% (e.g., 100% of a commission donated to charity). Note that, in some embodiments, a commission can be any suitable percentage of a sale (e.g., 2%, 5%, and/or any other suitable percentage). In some such embodiments, the portion of the commission to be donated can be taken from the commission. For example, in an instance where a commission is 5% of a sale, and a recommended product is sold for $100, the commission can be $5. Continuing with this example, in an instance where a user of user interface 500 has set the portion of the commission that is to be donated to a charity at 50%, $2.50 can be donated to the charity.

In some embodiments, group of charities 504 can be any suitable charities that are available to receive a portion or all of a commission. For example, in some embodiments charities included in group 504 can be charities that have been vetted by and/or have agreed to partner with the recommendation platform associated with the recommendation server. In some embodiments, any suitable information can be presented in association with each charity in group of charities 504. For example, in some embodiments, as illustrated in FIG. 5, each charity can be presented in association with an icon or image associated with the charity. As another example, in some embodiments, a description of the charity can be presented.

Note that, in some embodiments, charities included in group of charities 504 can be personalized based on a user of the recommender device, based on the selected product that is to be recommended, and/or based on any other suitable information. For example, in some embodiments, charities in group of charities 504 can be ordered in a manner based on a likelihood that a user of the recommender device is to select each charity for donation. As a more particular example, in some embodiments, charities can be ranked or ordered based on charities the user of the recommender device has previously selected (e.g., previously selected charities can be presented first and/or in any other suitable manner). As another more particular example, in some embodiments, charities likely to be selected can be identified based on demographic information associated with the user of the recommender device. As a specific example, in some embodiments, charities that have frequently been selected by users belonging to similar demographic groups as the user of the recommender device can be presented first within group of charities 504. As another example, in some embodiments, charities in group of charities 504 can be ordered based on information related to the selected product that is to be recommended. As a more particular example, in some embodiments, charities identified as likely to be of interest to a person likely to purchase the selected product can be ranked more highly and/or presented in a more prominent location within group of charities 504. As a specific example, in an instance where the selected product is an item of women's clothing, charities identified as likely to be of interest to women can be ranked more highly and/or presented in a more prominent location within group of charities 504. As another specific example, in an instance where the selected product is an item (e.g., a toy, a book, and/or any other suitable item) typically purchased by people in a particular age range and/or other demographic (e.g., parents, people between 30 and 40, and/or any other suitable demographic), charities identified as likely to be of interest to people belonging to the particular demographic can be ranked more highly and/or presented in a more prominent location within group of charities 504.

Note that, in some embodiments, in instances where a manner in which charities are included in group of charities 504 is personalized based on information about a user of the recommender device and/or based on information related to the selected product that is to be recommended, the recommendation server can identify charities that are to be ranked more highly based on any suitable information. For example, in some embodiments, the recommendation server can perform any suitable data analysis and/or machine learning technique(s) to identify charities that have previously been selected by particular users, that are likely to be of interest to particular demographic groups, and/or any other suitable information. More detailed techniques for analyzing data associated with recommendations and/or product sales are described below in connection with 128.

Additionally, note that, in some embodiments, any other suitable commission information can be set at 112 of FIG. 1 by a user of the recommender device. For example, in some embodiments, the information can include information related to a bank account (e.g., a routing number of a bank, an account number of the user of the recommender device at a particular bank, and/or any other suitable information) at which payment associated with a commission can be deposited, and/or any other suitable information. Additionally, note that, in some embodiments, the commission information can be set at any suitable time. For example, in some embodiments, a user of the recommender device can set the commission information as default commission information to be used, regardless of which product is being recommended. That is, in some embodiments, commission information, such as a portion of a received commission that is to be donated to a particular charity, a selected charity, bank account information, and/or any other suitable commission information can be set before a particular product is selected for recommendation. In some embodiments, commission information can be changed or modified at any suitable time(s).

In some embodiments, the commission information can include information indicating that a portion of a commission is to be shared with a user of the recipient device. For example, in some embodiments, user interface 500 can include a slider (not shown) that allows a user of user interface 500 to select a percentage of a commission that is to be shared with the user of the recipient device.

Referring back to FIG. 1, at 114, the recommendation server can receive the commission information. In some embodiments, the recommendation server can store the commission information in any suitable manner. For example, in some embodiments, the commission information can be stored in connection with an identifier of the recommender device, in connection with an identifier of the selected product to be recommended, and/or in any other suitable manner.

At 116, the recommender device can receive a selection of a recipient of a recommendation of the product from the recommender. In some embodiments, the recommender device can additionally select a messaging interface or a messaging application through which the recommendation is to be transmitted to the recipient.

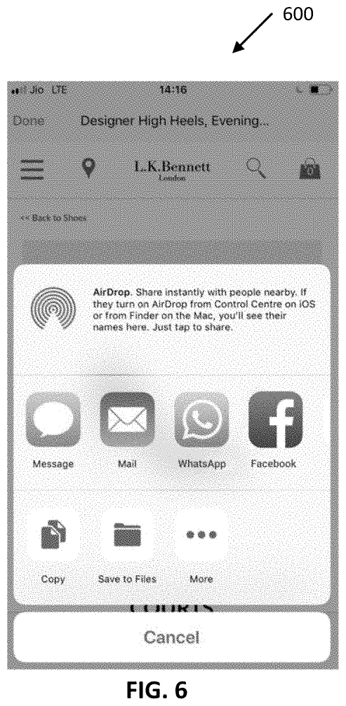

Turning to FIG. 6, an example 600 of a user interface for receiving a selection of a recipient of a recommendation and/or selecting a messaging interface through which a recommendation is to be transmitted is shown in accordance with some embodiments of the disclosed subject matter. As illustrated, user interface 600 can include an interface that allows a user of the recommender device to select a particular type of message and/or an application through which the recommendation is to be transmitted (e.g., via a text message, via an SMS or MMS message, via an email, via an application associated with a social networking service, and/or in any other suitable manner).

In some embodiments, a recipient of the recommendation can be selected in any suitable manner. For example, in some embodiments, a user of the recommender device can identify a friend from a contacts list presented on the recommender device. As another example, in some embodiments, a user of the recommender device can identify a contact connected with the user of the recommender device via a selected application, as described above in connection with FIG. 6. As a more particular example, in an instance where the recommendation is to be shared via a social networking service, the user of the recommender device can select a contact connected to the user of the recommender device via the social networking service. As yet another example, in some embodiments, a user of the recommender device can indicate any suitable identifying information of the recipient, such as a phone number, an email address, and/or any other suitable identifying information.

Referring back to FIG. 1, at 118, the recommendation server can cause a recommendation of the selected product to be transmitted to the recipient device. For example, in some embodiments, the recommendation server can cause a message that forms the recommendation and that includes a link (e.g., the recommendation server link described above) to the selected product to be transmitted to the recipient device.

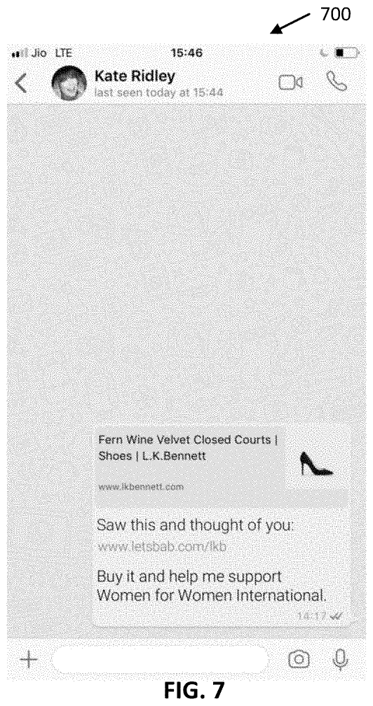

Turning to FIG. 7, an example 700 of a recommendation of the selected product presented within a messaging interface on the recipient device is shown in accordance with some embodiments of the disclosed subject matter. Note that, in some embodiments, the recommendation presented in the messaging interface can include any other suitable information. For example, in some embodiments, the recommendation can include an indication of a charity that a commission from purchase of the selected product would be split with. As a more particular example, in an instance where the recommender has indicated that a commission from purchase of the recommended product is to be split with a particular charity, the recommendation can include the name of the particular charity and/or an indication that the recommender has chosen the particular charity. Note that, in some embodiments, the recommendation can include a dollar amount that would be donated to the indicated charity if the product indicated in the message is purchased by a user of the recipient device.

Referring back to FIG. 1, at 120, the recipient device can select the link to the product. In some embodiments, selection of the link can cause the link to be opened within a browser window on the recipient device. Note that, in some embodiments, the link to the product can be a link to a page associated with the vendor server, for example, to purchase the product through an e-commerce platform of the vendor server.

In some embodiments, when the recipient (recommendee) opens the link, the link can report receipt of the link and opening of the recommendation to the recommendation server and the details of the pending recommendation. For example, in some embodiments, the recommender's ID, the product ID, and how much the product costs can be recorded in the recommendation server.

At 122, the vendor server can process a purchase of the product by the recipient device. For example, in some embodiments, the vendor server can receive any suitable payment information (e.g., credit card information, bank account information, information related to an account for online payments, and/or any other suitable payment information), shipping information, additional information about the product (e.g., a size of a clothing item to be purchased, a color of a clothing item to be purchased and/or any other suitable product information), and/or any other suitable information.

At 124, the vendor server can transmit information related to the purchase to the recommendation server. In some embodiments, the information can include any suitable information, such as a time the product was purchased, a date the product was purchased, a duration of time a page associated with the link to the product was open on the recipient device prior to the purchase, and/or any other suitable information. In some embodiments, the vendor server can transmit the information to the recommendation server in any suitable manner and/or using any suitable technique or combination of techniques. For example, in some embodiments, the information can be transmitted via a JavaScript script or other module of code that collects information from devices navigating a website associated with the vendor server.

At 126, the recommendation server can update one or more accounts based on the purchase. For example, in some embodiments, the recommendation server can update an account associated with the recommender device. As a more particular example, in some embodiments, the recommendation server can update the account associated with the recommender device to pay a commission associated with purchase of the recommended product. As another example, in some embodiments, the recommendation server can update an account associated with a charity that is to receive a portion of a commission associated with purchase of the recommended product. Note that, in some embodiments, the recommendation server can update the one or more accounts based on the purchase at any suitable time(s). For example, in some embodiments, the recommendation server can update the one or more accounts in response to determining that payment has been received from the vendor server. That is, in some embodiments, the vendor server can transmit a payment associated with the commission to the recommendation server, and the recommendation server can update the one or more accounts in response to determining that the payment has been received. As another example, in some embodiments, the recommendation server can update the one or more accounts at set time(s). As a more particular example, in some embodiments, the recommendation server can update an account associated with charities at any suitable frequency (e.g., every two weeks, and/or any other suitable time period). As another more particular example, in some embodiments the recommendation server can update an account associated with recommenders (e.g., users who have accounts with the recommendation platform) at any suitable frequency (e.g., every two weeks, and/or any other suitable time period).

Note that, in some embodiments, in instances in which a purchased product is returned, the recommendation server can update accounts associated with the recommender device and/or with a charity that received a portion of a commission in any suitable manner. For example, in some embodiments, the recommendation server can receive an indication from the vendor server that a particular product has been returned by a user of the recipient device. In some such embodiments, the recommendation server can then deduct the commission paid to an account associated with the recommender device and/or deduct a donation paid to an account associated with a particular charity in connection with the commission.

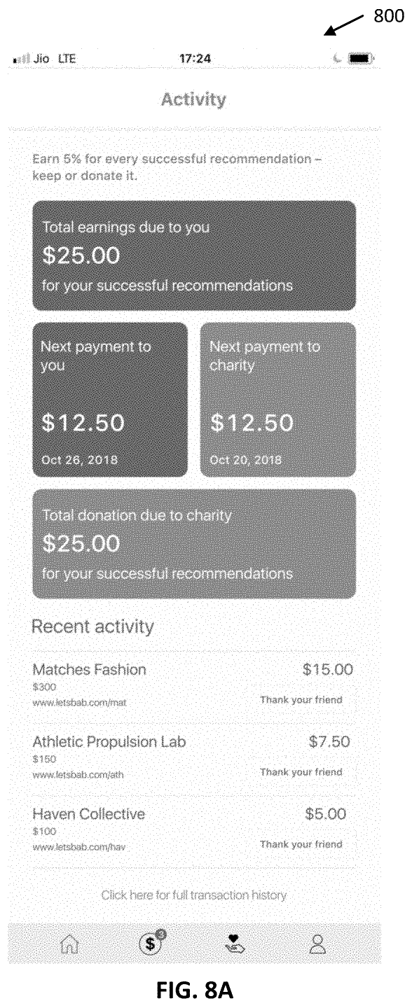

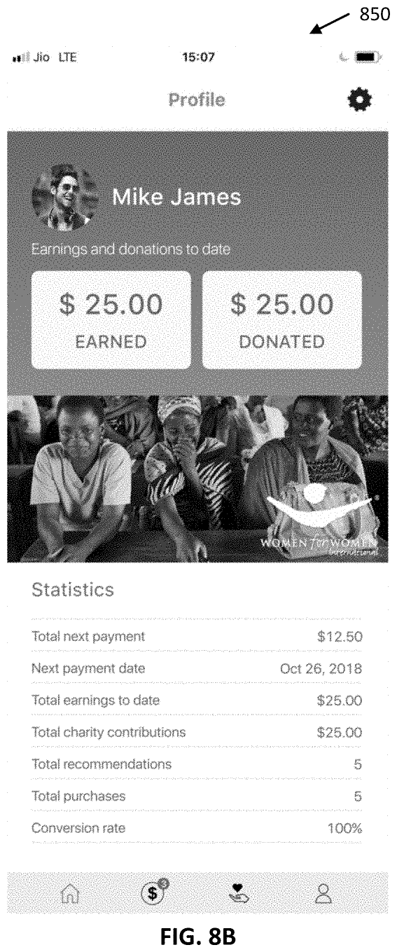

Additionally, note that, in some embodiments, information associated with an account can be viewed in any suitable manner. For example, in some embodiments, a user of the recommender device can view information associated with the account. Turning to FIGS. 8A and 8B, examples 800 and 850 of user interfaces for viewing information associated with an account of a recommender are shown in accordance with some embodiments of the disclosed subject matter.

As illustrated in user interface 800, in some embodiments, account information can indicate a total commission amount earned by a user of the recommender device, a date the user is to receive a next commission payment, a date a charity selected by the user is to receive a next payment, a total amount the user has donated to charity, recent activity (e.g., recent commissions earned based on product recommendations, and/or any other suitable recent activity), and/or any other suitable information.

As illustrated in user interface 850, in some embodiments, account information can indicate any suitable statistical information related to a recommendation made by a user of the recommender device. For example, as shown in user interface 850, statistical information can include a total number of recommendations made through the recommendation platform, a percentage of recommendations that resulted in purchases by recipients of the recommendations and/or any other suitable information.

Referring back to FIG. 1, at 128, the recommendation server can update data associated with the product recommendation and/or purchase of the recommended product. For example, in some embodiments, the recommendation server can update any suitable data stored on the recommendation server that indicates that a particular product was recommended by a user of the recommender device, that the recommended product was purchased by a user of the recipient device, that the recommended product was purchased and that the message included a notification that a particular charity would receive a donation based on purchase of the recommended product, and/or any other suitable information. Note that, in instances in which the recommended product was not purchased, the recommendation server can update the data to indicate that the recommended product was not purchased by the user of the recipient device. Additionally, note that, in some embodiments, the data stored by the recommendation server can additionally include any suitable data received from the vendor server, as described above in connection with 108 and/or 124. For example, in some embodiments, the data can include information collected by the vendor server using a JavaScript tracking code embedded in a website associated with the vendor server, as described above.

In some embodiments, the recommendation server can store data relating to product recommendations and/or related to product purchases in any suitable manner. For example, in some embodiments, the recommendation server can store the data in a database that associates product information with user information, thereby allowing the database to be queried to return any suitable information. For example, in some embodiments, a query to the database can request information indicating vendors or types of products most likely to be recommended by a particular demographic group (e.g., by a particular gender, by people of a particular age group, and/or any other suitable demographic group). As another example, in some embodiments, a query to the database can request information indicating a percentage of recommenders within a particular demographic group who split commissions with a charity.

Note that, in some embodiments, any suitable data analysis and/or machine learning techniques can be applied by the recommendation server to data collected and/or received by the recommendation server. For example, in some embodiments, the recommendation server can use any suitable classification algorithms to classify users of the recommendation platform. As a more particular example, in some embodiments, the recommendation server can classify users of the recommendation platform as users who split commissions with charities, users whose recommendations result in a high percentage of purchases, users whose recommendations result in a low percentage of purchases, users who recommend relatively low-cost products, users who recommend relatively high-cost products, users who tend to recommend particular types of products (e.g., casual clothing, books, toys, etc.), and/or any other suitable groups. As another example, in some embodiments, the recommendation server can use any suitable algorithms for identifying similar entities, such as vendors that are similar to a particular vendor, charities that are similar to a particular charity, and/or any other suitable similarities. As a more particular example, in some embodiments, the recommendation server can use any suitable algorithm (e.g., collaborative filtering, any suitable classification algorithm, a neural network, and/or any other suitable algorithm) to identify a group of vendors similar to a particular vendor based on any suitable inputs, such as products sold by the vendors, users who have purchased products from the vendors, demographics of users who have purchased products from the vendors, and/or any other suitable information. As another more particular example, in some embodiments, the recommendation server can use any suitable algorithm (e.g., collaborative filtering, any suitable classification algorithm, a neural network, and/or any other suitable algorithm) to identify a group of charities similar to a particular charity based on any suitable inputs, such as users who have selected particular charities to donate to, products recommended by users who have selected particular charities to donate to, demographics of users who have selected particular charities to donate to, and/or based on any other suitable information.

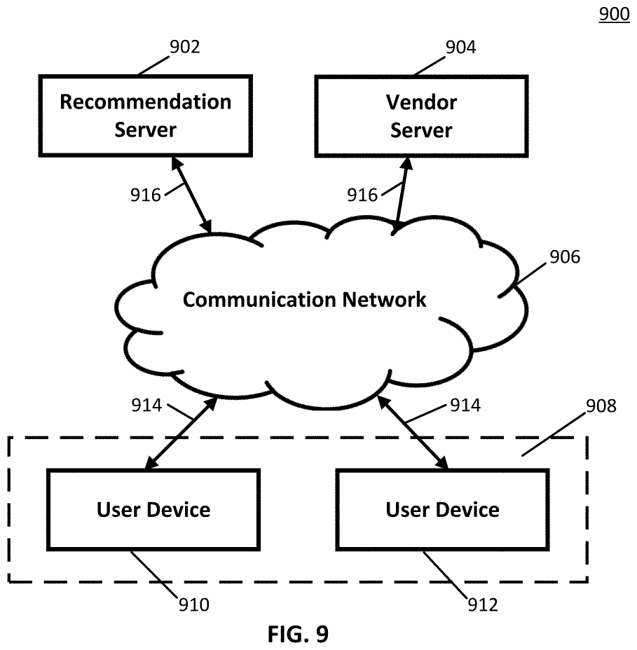

Turning to FIG. 9, an example 900 of hardware for coordinating recommendations that can be used in accordance with some embodiments of the disclosed subject matter is shown. As illustrated, hardware 900 can include a recommendations server 902, a vendor server 904, a communication network 906, and/or one or more user devices 908, such as user devices 910 and 912.

Recommendation server 902 can be any suitable server for coordinating product recommendations from a user of a first user device to a user of a second user device, determining products likely to be of interest to a user, coordinating payment of a commission to a user of a first user device and/or a charity, and/or performing any other suitable functions. In some embodiments, recommendation server 902 can be associated with any suitable entity, such as a business associated with a platform that allows users to purchase products from different vendors, and/or any other suitable business.

Vendor server 904 can be any suitable server associated with a vendor of a product (e.g., clothing, books, toys, etc.). In some embodiments, vendor server 904 can perform any suitable actions, such as causing available products to be presented on a user device, transmitting information related to products that have been browsed or purchased to recommendation server 902, and/or performing any other suitable functions.

Communication network 906 can be any suitable combination of one or more wired and/or wireless networks in some embodiments. For example, communication network 906 can include any one or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. User devices 908 can be connected by one or more communications links (e.g., communications links 914) to communication network 906 that can be linked via one or more communications links (e.g., communications links 916) to server(s) 902 and/or 904. The communications links can be any communications links suitable for communicating data among user devices 908 and server(s) 902 and/or 904, such as network links, dial-up links, wireless links, hard-wired links, any other suitable communications links, or any suitable combination of such links.

User devices 908 can include any one or more user devices suitable for selecting a product to recommend, receiving a product recommendation, purchasing a product, and/or performing any other suitable functions. In some embodiments, user devices 908 can include any suitable type(s) of user devices. For example, in some embodiments, user devices 908 can include a mobile phone, a tablet computer, a laptop computer, a desktop computer, a wearable computer, and/or any other suitable type of user device.

Although servers 902 and 904 are each illustrated as one device, the functions performed by servers 902 and 904 can be performed using any suitable number of devices in some embodiments. For example, in some embodiments, multiple devices can be used to implement the functions performed by server 902.

Although two user devices 910 and 912 are shown in FIG. 9 to avoid over-complicating the figure, any suitable number of user devices, and/or any suitable types of user devices, can be used in some embodiments.

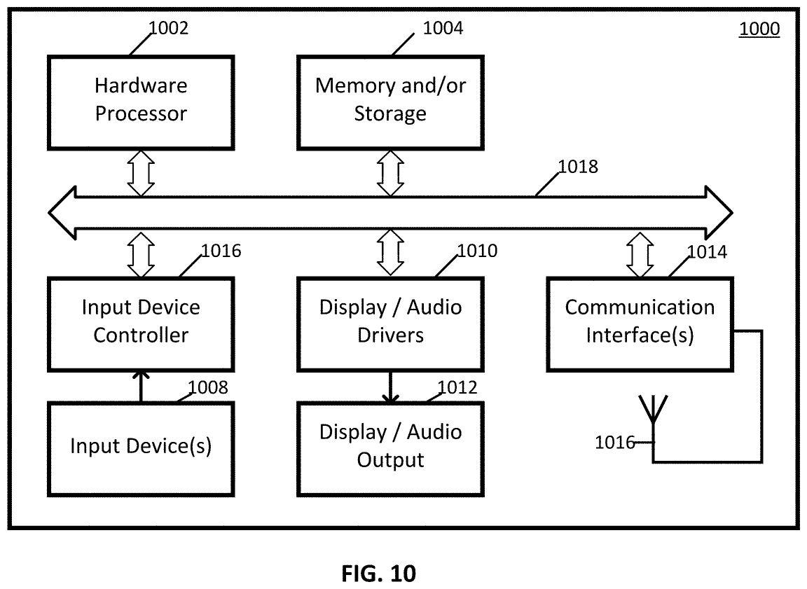

Servers 902 and 904 and user devices 908 can be implemented using any suitable hardware in some embodiments. For example, in some embodiments, devices 902, 904, and 908 can be implemented using any suitable general-purpose computer or special-purpose computer. For example, a mobile phone may be implemented using a special-purpose computer. Any such general-purpose computer or special-purpose computer can include any suitable hardware. For example, as illustrated in example hardware 1000 of FIG. 10, such hardware can include hardware processor 1002, memory and/or storage 1004, an input device controller 1006, an input device 1008, display/audio drivers 1010, display and audio output circuitry 1012, communication interface(s) 1014, an antenna 1016, and a bus 1018.

Hardware processor 1002 can include any suitable hardware processor, such as a microprocessor, a micro-controller, digital signal processor(s), dedicated logic, and/or any other suitable circuitry for controlling the functioning of a general-purpose computer or a special-purpose computer in some embodiments. In some embodiments, hardware processor 1002 can be controlled by a server program stored in memory and/or storage of a server, such as recommendation server 902 and/or vendor server 904. In some embodiments, hardware processor 1002 can be controlled by a computer program stored in memory and/or storage of a user device, such as user device 908.

Memory and/or storage 1004 can be any suitable memory and/or storage for storing programs, data, and/or any other suitable information in some embodiments. For example, memory and/or storage 1004 can include random access memory, read-only memory, flash memory, hard disk storage, optical media, and/or any other suitable memory.

Input device controller 1006 can be any suitable circuitry for controlling and receiving input from one or more input devices 1008 in some embodiments. For example, input device controller 1006 can be circuitry for receiving input from a touchscreen, from a keyboard, from one or more buttons, from a voice recognition circuit, from a microphone, from a camera, from an optical sensor, from an accelerometer, from a temperature sensor, from a near field sensor, from a pressure sensor, from an encoder, and/or any other type of input device.

Display/audio drivers 1010 can be any suitable circuitry for controlling and driving output to one or more display/audio output devices 1012 in some embodiments. For example, display/audio drivers 1010 can be circuitry for driving a touchscreen, a flat-panel display, a cathode ray tube display, a projector, a speaker or speakers, and/or any other suitable display and/or presentation devices.

Communication interface(s) 1014 can be any suitable circuitry for interfacing with one or more communication networks (e.g., computer network 906). For example, interface(s) 1014 can include network interface card circuitry, wireless communication circuitry, and/or any other suitable type of communication network circuitry.

Antenna 1016 can be any suitable one or more antennas for wirelessly communicating with a communication network (e.g., communication network 906) in some embodiments. In some embodiments, antenna 1016 can be omitted.

Bus 1018 can be any suitable mechanism for communicating between two or more components 1002, 1004, 1006, 1010, and 1014 in some embodiments.

Any other suitable components can be included in hardware 1000 in accordance with some embodiments.

In some embodiments, at least some of the above described blocks of the process of FIG. 1 can be executed or performed in any order or sequence not limited to the order and sequence shown in and described in connection with the figures. Also, some of the above blocks of FIG. 1 can be executed or performed substantially simultaneously where appropriate or in parallel to reduce latency and processing times. Additionally or alternatively, some of the above described blocks of the process of FIG. 1 can be omitted.

In some embodiments, any suitable computer readable media can be used for storing instructions for performing the functions and/or processes herein. For example, in some embodiments, computer readable media can be transitory or non-transitory. For example, non-transitory computer readable media can include media such as non-transitory forms of magnetic media (such as hard disks, floppy disks, and/or any other suitable magnetic media), non-transitory forms of optical media (such as compact discs, digital video discs, Blu-ray discs, and/or any other suitable optical media), non-transitory forms of semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Accordingly, methods, systems, and media for coordinating recommendations are provided.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A method for coordinating recommendations, comprising:
receiving a first link that identifies a product to be recommended by a recommender and that is associated with a vendor server associated with a first domain;
creating, using a hardware processor, a second link from the first link, wherein the second link identifies the product and wherein the second link is associated with a second domain that is different from the first domain;
sending the second link to a recipient device as part of a recommendation of the product;
determining, using the hardware processor, that the second link has been selected by a user of the recipient device;
redirecting the recipient device to a vendor server identified by the first link;
receiving information that a purchase was made in connection with the recommendation of the product; and
causing a display to present commission information based on the purchase.

2. The method of claim 1, wherein the first link identifies a uniform resource locator corresponding to the product.

3. The method of claim 2, wherein the first link identifies an identifier of the recommender.

4. The method of claim 3, wherein the first link identifies a time of the recommendation.

5. The method of claim 1, wherein the commission is a commission paid to the recommender.

6. The method of claim 1, wherein the commission is a commission paid to a charity.

7. The method of claim 1, further comprising receiving a selection of a sharing ratio of a commission between a recommender and a charity.

8. A system for coordinating recommendations, comprising:
a memory; and
a hardware processor coupled to the memory and configured to:
receive a first link that identifies a product to be recommended by a recommender and that is associated with a vendor server associated with a first domain;
create a second link from the first link, wherein the second link identifies the product and wherein the second link is associated with a second domain that is different from the first domain;
send the second link to a recipient device as part of a recommendation of the product;
determine that the second link has been selected by a user of the recipient device;
redirect the recipient device to a vendor server identified by the first link;
receive information that a purchase was made in connection with the recommendation of the product; and
cause a display to present commission information based on the purchase.

9. The system of claim 8, wherein the first link identifies a uniform resource locator corresponding to the product.

10. The system of claim 9, wherein the first link identifies an identifier of the recommender.

11. The system of claim 10, wherein the first link identifies a time of the recommendation.

12. The system of claim 8, wherein the commission is a commission paid to the recommender.

13. The system of claim 8, wherein the commission is a commission paid to a charity.

14. The system of claim 8, further comprising receiving a selection of a sharing ratio of a commission between a recommender and a charity.

15. A non-transitory computer-readable medium containing computer executable instructions that, when executed by a processor, cause the processor to perform a method for coordinating recommendations, the method comprising:
receiving a first link that identifies a product to be recommended by a recommender and that is associated with a vendor server associated with a first domain;
creating a second link from the first link, wherein the second link identifies the product and wherein the second link is associated with a second domain that is different from the first domain;
sending the second link to a recipient device as part of a recommendation of the product;
determining that the second link has been selected by a user of the recipient device;
redirecting the recipient device to a vendor server identified by the first link;
receiving information that a purchase was made in connection with the recommendation of the product; and
causing a display to present commission information based on the purchase.

16. The non-transitory computer-readable medium of claim 15, wherein the first link identifies a uniform resource locator corresponding to the product.

17. The non-transitory computer-readable medium of claim 16, wherein the first link identifies an identifier of the recommender.

18. The non-transitory computer-readable medium of claim 17, wherein the first link identifies a time of the recommendation.

19. The non-transitory computer-readable medium of claim 15, wherein the commission is a commission paid to the recommender.

20. The non-transitory computer-readable medium of claim 15, wherein the commission is a commission paid to a charity.

21. The non-transitory computer-readable medium of claim 15, wherein the method further comprises receiving a selection of a sharing ratio of a commission between a recommender and a charity.
